(19) United States
(12) Patent Application Publication
(10) Pub. No.: US 2007/0184734 A1
(43) Pub. Date: Aug. 9, 2007

(54) Moisture absorbing wrap

(76) Inventor: Hamish Andrew Ramsay, Brigg (GB)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/347,949

(22) Filed: Feb. 6, 2006

(51) Int. Cl. B32B 33/00; B32B 27/04; B32B 7/12

(52) U.S. Cl. 442/149; 428/343; 428/41.8; 428/40.1

(57) ABSTRACT

An absorbent wrap for absorbing moisture condensate running down a chilled container, the wrap comprising a length of absorbent material having a first end and a second end, at least one end having a means for attaching the two ends together to hold the wrap in position. The wrap can be made of fibrous material, such as paper or cardboard, woven material, such as fabric, nonwoven material, such as polymeric filaments, or can be a multilayer material. The attaching means can be adhesive, hook and loop fastener material or the like.

### FIELD OF THE INVENTION

The present invention relates to moisture absorbing devices, and, more particularly, to a wrap which can absorb moisture which has condensed on the outside of a beverage container.

### BACKGROUND OF THE INVENTION

Coasters have commonly been used to absorb the condensed moisture that falls from the exterior of drink or other containers that “sweat” due to the temperature differential between the interior (cooler) and the exterior (warmer) surfaces of the container. The coaster rests underneath the container. A problem with a conventional paper, cardboard or other coaster material is that the wet container bottom sticks to the coaster so that when the user raises the container the coaster often stays stuck to the bottom of the container and may fall off when the user tilts the container to drink. Furthermore, when a user takes the drink container and moves to a different place, the coaster often remains behind. Without a coaster, a sweating drink container produces sufficient droplets of water to drip onto a user's clothing as the vessel is moved during drinking, etc., which, if stainable, can cause damage or an undesirable drip mark in a social situation.

It would be desirable to have a device that could absorb the condensate moisture from a drink container and remain with the container.

### SUMMARY OF THE INVENTION

Generally described, the present invention provides in a first embodiment a length of absorbent material which can be wrapped around a container and maintained in a generally stable position. One end portion of the material may have an adhesive material, or adhesive device coated, affixed, or formed thereon which adhesive or adhesive device may be affixed to the second end portion. The material can be an absorbent cellulose or fibrous material, such as, but not limited to, paper, paper towel-like material, cardboard, or the like. Alternatively, the material may be a woven material, such as, but not limited to fabric, terrycloth, or the like. Further, as an alternative, the material may be a nonwoven material, such as but not limited to, finely spun polymer filaments, similar to those used to make diaper material. Alternatively, the material may be multiple layers of the same or different material. The material may also be a laminate of a plurality of layers. The material may also have two exterior faces of material between which is sandwiched a third layer, such as but not limited to an absorbent or superabsorbent material. Such absorbent or superabsorbent material may be powdered, gelatinous, granular, fibrous, particulate or the like. Preferably, the external surface of the length of absorbent material can have at least a portion of the surface capable of being printed on or otherwise have indicia formed thereon or therein, such as for advertising. The material may also be colored or take on a color.

Preferably, the wrap of the present invention is wrapped around a drink container at the lower portion of the container so as to absorb moisture condensate which may drip down the side of the chilled container. The wrap may be held in place by the adhesive. Alternatively, a hook and loop set of mating fasteners can be affixed to the end portions of the wrap, with the hook portion being at one end and the loop portion being at the other end. Alternatively, the material may be formed with a shape memory material associated therewith, such as, but not limited to, a wire strand running at least a portion of the length of the material so as to bias the material in a coiled fashion. In a preferred embodiment the ends of the wrap are overlaid with each other. Alternatively, the ends can be offset, as when the wrap is substantially longer than the circumference of the container and the wrap is helically-wrapped around at least a portion of the container.

It will be appreciated that while one significant use of the present invention is in connection with a chilled drink container, the wrap of the present invention can also be used to absorb moisture from other surfaces, such as pipes, conduits or the like.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of an exemplary embodiment of the present invention.

FIG. 2 is a front elevational view of the exemplary embodiment of FIG. 1.

FIG. 3 is a front elevational view of a drink container with an exemplary embodiment of the present invention in place.

FIG. 4 is a front elevational view of an exemplary alternative embodiment.

### DETAILED DESCRIPTION OF THE INVENTION

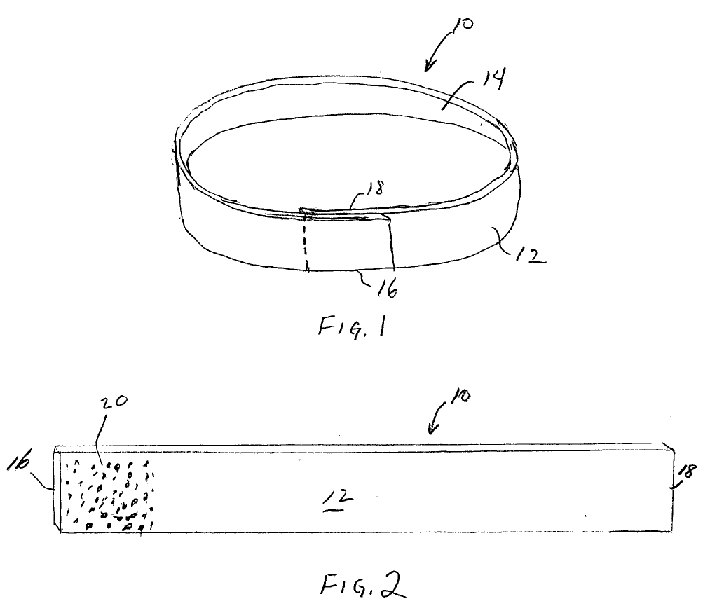

FIG. 1 shows one exemplary embodiment of the present invention comprising a wrap 10 having a front surface 12, a back surface 14, a first end 16 and a second end 18. The wrap 10 is made of a material capable of absorbing moisture. The wrap 10 may be made of material, such as, but not limited to, paper, other cellulose or fibrous formed material, terrycloth, mesh material, woven or nonwoven fibers, a mat of fibrous material, polymers, polysilicate or other absorbent gels, superabsorbent material, mixtures or combinations thereof, and the like. In a preferred embodiment the material is paper having a degree of absorbency. It is preferable for such paper or other material not to appreciably degrade or dissolve upon exposure to moisture, nor to suffer undue physical expansion.

The wrap 10 may be of a one piece construction, or, alternatively, have two exterior faces of material, such as fabric, and an interior material, such an absorbent gel or other absorbent material. In such an alternative embodiment the peripheries of the exterior material are sewn, adhered or otherwise joined together so that the interior material is maintained substantially within the wrap.

In another alternative embodiment, the wrap 10 can be made of a plurality of layers of material, so as to, for example, promote absorbance from the exterior layers to the interior layers (similar in function to a diaper wicking away moisture from the skin to the interior or remote portion of the diaper).

The wrap 10 can be made of a material that is colored. The front surface 12 can have graphics or other indicia thereon, such as by printing, embossing, painting, spraying, or the like. Accordingly, advertising can be associated with the wrap 10 for increased brand visibility and increase revenue generation.

The height of the wrap 10 can be designed as desired. The width of the wrap 10 can also be made as desired to accommodate various container sizes.

The first end 16 has on its back surface 14 a means for permanently or removably joining the first end 16 back surface 14 to the second end 18 front surface 14. Such means may be glue, self-adhesive, or the like. Alternatively, a hook or loop material can be utilized whereby the hook material is affixed to the first end 16 back surface 14 and the loop material is affixed to the second end 18 front surface 12. Alternatively, adhesive tape material can be utilized whereby the tape material is affixed to the first end 16 back surface 14 and subsequently to the second end 18 front surface 12. Alternatively, self-adhesive can be applied to the first end 16 back surface 14 and also to the second end 18 front surface 14 such that when the wrap 10 is wrapped around the container the first end 16 and second end 18 overlap and the self-adhesive portions contact each other, thus forming the connection. Alternatively, adhesive can be applied to the first end 16 front surface 12 such that when the wrap is wrapped around the container the first end 16 and second end 18 overlap and the adhesive completes the connection to the front surface 12 of the second end 18.

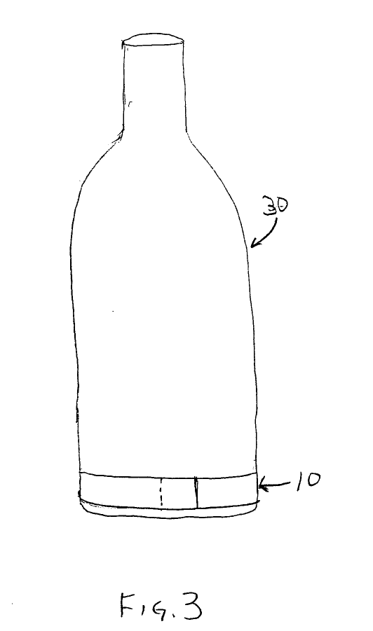

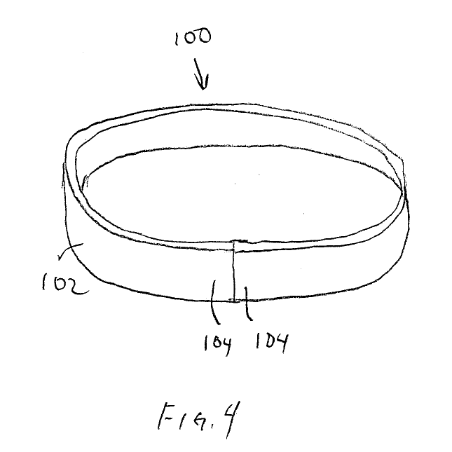

The wrap 10 may advantageously be placed toward the bottom of a container 30, as shown in FIG. 3. In this manner the wrap 10 will absorb moisture falling down substantially the entire length the side of the container 30. Alternatively, the wrap 10 can be applied at any height above the bottom of the container 30.

In another alternative embodiment, the wrap 10 can be constructed so that the first and second ends are affixed to each other, either overlapping, or end-to-end joining. In this alternative embodiment the wrap 10 is preferably made of an elastic absorbent material, such as fabric. The wrap 10 can be stretched to fit over the circumference of the container and contract to remain around the container.

It is to be understood that while a drink container may be one common intended use of the present invention, other uses are anticipated, such as, but not limited to, protecting various pipes or conduits which sweat. The height or width of the wrap 10 or the amount of the overlap region of the ends 16, 18 can be changed to suit the needs of the user. It is also to be understood that containers having cross-sectional shapes other than circular can be used with the present invention.

It is to be understood that while the general shape of the wrap 10 is rectangular, such shape can be changed as desired. A curved, spiral or helical wrap shape can be used, as well as other geometry. In one such modification, the wrap can be elongated so as to wrap around the container more than one circumference, i.e., in spiral around the container.

In a further alternative embodiment, the material from which the wrap is made can have shape memory characteristics so that the wrap can be in an initial small diameter ring and expand to fit snugly over a container and remain in place by virtue of the spring-like qualities of the shape memory material. The wrap material can incorporate a metal, polymeric, alloy or other material or combinations thereof, such as, but not limited to, at least one wire filament or thread which urges the wrap as a whole into a ring having a diameter smaller than the container. The wire can be metal, plastic, polymeric, ceramic, mixtures of the foregoing or other material having suitable shape memory characteristics sufficient to provide sufficient spring-biasing energy to maintain the wrap 10 in place around the container 30. In this alternative embodiment, an adhesive or other attachment means for the first and second ends may not be necessary.

The wrap of the present invention, when made of paper, cardboard or similar fibrous or other material, can be formed into a long roll having perforations at preselected positions so that one wrap can be separated from the roll at the perforation, or at regular, smaller intervals such that a convenient number of sections can be separated. Adhesive can be coated onto the material at selected points. For a roll embodiment or for strips as described above, a pressure sensitive release strip can be used to protect the coated adhesive and prevent it from sticking to the wrong surface until needed. Such a strip, often having one surface coated with silicone, is well known to those skilled in the art.

In still another exemplary embodiment, shown in FIG. 4, a wrap 100 made of a strip of material 102 has a first end 104 and a second end 106, whereby the first and second ends 102, 104 are not affixed to each other, but are maintained in proximity or in an abutting relationship to one another by virtue of the material or combination of materials from which the wrap 100 is made. Materials having at least some shape memory properties will enable the wrap 100 to be expanded to fit over a container and then the wrap 100 is biased to attempt to return to its original orientation, thereby gripping the outside of the container.

In yet a further alternative embodiment, the container bottler can adhere a wrap onto the exterior of the container when it is being processed and labels are being affixed. In such an embodiment the wrap may be formed with the adhesive along generally the entire back surface. The front surface can be printed with primary or secondary or cobranding advertising, e.g., advertising the container's contents, or another product (such as, the wrap having an advertisement for peanuts where it is attached to a beer bottle to encourage the drinker to have or buy a particular brand of peanuts).

It is also possible for the wrap of the present invention to be designed out of a heat resistant or insulative material so that a user can grasp a container that contains a hot beverage without being burned, or a cold container without discomfort.

One advantage of the present invention is that a user can take his or her drink and have a moisture absorber without having to take a separate coaster. Another advantage is that when the user tips the container to take a drink condensed moisture can run down the container and be absorbed by the wrap 10. A further advantage is that the wrap of the present invention can reduce the likelihood of a water stain ring developing on the surface on which the container is placed. If a container with the wrap of the present invention is placed on a coaster, the likelihood of a water ring forming is even further reduced. Still another advantage is that the wrap of the present invention can accommodate printing for advertising or other purposes. The advertising would be seen more frequently than a coaster because the coaster is essentially covered up when the container rests thereon, whereas advertising on the wrap is seen continuously.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

It should further be noted that any patents, applications and publications referred to herein are incorporated by reference in their entirety.

What is claimed is:

1. A moisture absorbing wrap, comprising:
a) a length of moisture absorbing material having
i) a front surface,
ii) a rear surface,
iii) a first end and
iv) a second end; and,
b) a means for associating said wrap with the exterior of a container or other surface.

2. The wrap of claim 1, wherein said first end is associated with said second end.

3. The moisture absorbing wrap of claim 1, wherein said material is fibrous.

4. The moisture absorbing wrap of claim 1, wherein said material is selected from the group consisting of fibrous material, mesh material, paper, woven fabric, nonwoven material, terrycloth, combinations of fibrous and nonwoven material, absorbent gels, and polysilicate gels.

5. The moisture absorbing wrap of claim 1, wherein said material is a mat of fibrous material.

6. The moisture absorbing wrap of claim 1, wherein said means for associating comprises an adhesive.

7. The moisture absorbing wrap of claim 5, wherein said means for associating further comprises a protective strip of material that covers the adhesive and which can be removed by a user prior to use.

8. The moisture absorbing wrap of claim 1, wherein said means for associating comprises a hook and loop material whereby said hook material is associated with said first end and said loop material is associated with said second end.

9. The moisture absorbing wrap of claim 1, wherein said means for associating comprises a fastener.

10. The moisture absorbing wrap of claim 1, wherein said means for associating comprises at least one wire filament associated with said wrap, said wire having shape memory characteristics.

11. A moisture absorbing wrap, comprising:
a) a length of moisture absorbing fibrous paper material having
i) a front surface,
ii) a rear surface,
iii) a first end and
iv) a second end; and,
b) an effective amount of an adhesive associated with said first end such that pressing said adhesive and first end onto a portion of said second end causes said adhesive to adhere to said second end
c) a portion of said paper material having sufficient space to accommodate indicia thereon.

12. The wrap of claim 10, wherein said indicia are printed, embossed, or adhered on to said paper material.

13. A moisture absorbing wrap, comprising:
a) an annulus of moisture absorbing material having
i) a front surface, and
ii) a rear surface; and
b) said material having sufficient elasticity to enable it to be wrapped around a container and remain wrapped around said container.

14. A moisture absorbing wrap, comprising:
a) an annulus of moisture absorbing material having
i) a front surface, and
ii) a rear surface; and
b) said material having shape memory characteristics so as to urge said wrap to generally maintain a defined shape.
